(19) United States
(12) Patent Application Publication
(10) Pub. No.: US 2014/0219908 A1
(43) Pub. Date: Aug. 7, 2014

(54) METHODS OF PRODUCING COILED CARBON NANOTUBES

(71) Applicant: Troy Tomasik, Mount Pleasant, SC (US)

(72) Inventor: Troy Tomasik, Mount Pleasant, SC (US)

(21) Appl. No.: 14/241,929

(22) PCT Filed: Aug. 30, 2011
(86) PCT No.: PCT/US2011/049649

§ 371 Date: Feb. 28, 2014

(51) Int. Cl. C01B 31/02; C01B 31/06

(52) U.S. Cl. CPC C01B 31/0233; C01B 31/06; C01B 2202/06; C01B 2202/36
USPC 423/446; 423/447.1; 423/447.3; 423/447.7

(57) ABSTRACT

Methods and systems for producing coiled nanotubes. At least one exemplary method of producing coiled carbon nanotubes of the present disclosure comprises the steps of reacting a carbon feedstock and a catalyst within a reaction vessel to produce a reaction product comprising at least about 5% coiled carbon nanotubes, wherein the carbon feedstock comprises either (i) a mixture of a hydrocarbon and water or (ii) an alcohol, and wherein the catalyst comprises at least one Group VIB or VIIIB transition metal.

### BACKGROUND

Carbon nanotubes are tubules comprised of carbon and generally having a length of from 5 to 100 micrometers and a diameter of from 5 to 100 nanometers. These nanotubes are geometrically described as a seamless cylinder of a rolled graphene sheet for single walled nanotubes, or multiple nested cylinders of rolled graphene sheets for multi-walled nanotubes. Because of their construction, carbon nanotubes have many desirable properties such as a high strength and low weight compared with volume, energy and fuel storage capability, electron emission capability and many advantageous thermal, chemical and surface properties. Different utilities for carbon nanotubes have been investigated, such as for composite materials, fuel cells, fuel emission devices, catalysts, filtration and purification, sensors and microelectro mechanical manufacturing systems technology.

As an alternative to straight carbon nanotubes, coiled nanotubes have been identified which possess many of the same strength to weight properties, but in addition often possess additional three-dimensional or off-axis strength relative to their straight counterparts.

Although carbon nanotubes have many advantageous properties, successful commercial application of these structures have not yet been reported due to the difficulty in synthesis capacity, manipulation and structural controllability of the carbon nanotubes. Therefore, there is a need for a method and systems which enables the synthesis of uniform carbon nanotubes, particularly coiled carbon nanotubes, in a cost effective and easily controllable method.

### BRIEF DESCRIPTION

Disclosed herein are various methods for producing coiled carbon nanotubes. In at least one embodiment of a method of producing coiled carbon nanotubes, the method comprises the steps of reacting a carbon feedstock and a catalyst within a reaction vessel to produce a reaction product comprising at least about 5% coiled carbon nanotubes, wherein the carbon feedstock comprises either (i) a mixture of a hydrocarbon and water or (ii) an alcohol, and wherein the catalyst comprises at least one Group VIB or VIIIB transition metal. The carbon feedstock in an exemplary embodiment of the method may comprise an alcohol, such as one selected from a group consisting of methanol, ethanol, butyl alcohol, and propyl alcohol. Further, the carbon feedstock may comprise a hydrocarbon having three or greater carbon atoms. Additionally, the carbon feedstock may further comprise a carrier gas, such as an inert gas, or one selected from the group consisting of a noble gas, N₂, and either a noble gas or N₂ combined with one or more of CO, CO₂, H₂O, and H₂.

In at least one embodiment of the method of the present disclosure, the at least one Group VIB or VIIIB transition metal is selected from the group consisting of chromium, molybdenum, tungsten, iron, ruthenium, osmium, cobalt, rhodium, iridium, and a bimetallic combination thereof. The bimetallic combination may in at least one embodiment of the method be Fe and Co. In at least one embodiment of the method of the present disclosure, the catalyst comprises a metal selected from the group consisting of Fe, Co, and Fe combined with one or more of Co, Mo, or W.

In at least one embodiment of the method of the present disclosure, the catalyst is supported by an inactive substrate selected from the group consisting of alumina, silica, and magnesia. Further, in an embodiment of the method, the step of reacting the carbon feedstock with the catalyst uses a process flow selected from the group consisting of a fluidized bed, entrained bed, raining bed, and direct injection.

In at least one embodiment of the method of the present disclosure, the method further comprises the step of heating the reaction vessel to a reaction temperature selected from the group consisting of about 400° C. to about 1200° C., about 550° C. to about 1000° C., about 600° C. to about 825° C., and about 625° C. to about 700° C.

In at least one embodiment of the method of the present disclosure, the method further comprises the step of pressurizing the reaction vessel to an internal pressure selected from a group consisting of about 14.7 pound per square inch absolute (psia) to about 65 psia, about 14.7 psia to about 45 psia, about 14.7 psia to about 30 psia, and about 14.7 psia to about 20 psia.

The step, according to an embodiment of the present disclosure, of introducing carbon feedstock into the reactor may occur at a feedstock partial pressure selected from at least about 10%, at least about 20%, at least about 30%, at least about 40%, at least about 50%, at least about 60%, and at least about 70%.

In at least one embodiment of the method of the present disclosure, the coiled carbon nanotube may be single walled or multi-walled. Additionally, the coiled carbon nanotube may have a coil length of about 0.05 μm to about 10 mm and a diameter of about 1 nm to about 500 nm. Further, the coiled carbon nanotube may have either a coil length from about 0.05 to about 10 mm or a diameter of about 1 nm to about 500 nm.

In at least one embodiment of the method of the present disclosure, the reaction product comprises a diamond nanoparticle.

In at least one embodiment of the method of the present disclosure, the reaction vessel is part of a fluidized bed system.

In at least one embodiment of the method or system of the present disclosure, the carbon feedstock may comprise any one of (i) a mixture of a hydrocarbon and water, (ii) an alcohol, (iii) ethanol, (iv) ethylene and water, or (v) ethane and water.

In at least one embodiment of the system of the present disclosure, the system comprises a carbon feedstock container containing a carbon feedstock comprising either (i) a mixture of a hydrocarbon and water or (ii) an alcohol, and a reaction vessel having an inlet, an outlet, and a vessel containing a catalyst comprising at least one Group VIB or VIIIB transition metal, the inlet operably coupled to the carbon feedstock container, and wherein the reaction vessel is operable for receipt of the carbon feedstock through the inlet, wherein when the carbon feedstock contacts the catalyst in the reaction chamber, the catalyst catalyzes a reaction producing a reaction product comprising at least 5% coiled carbon nanotubes.

In at least one embodiment of the system of the present disclosure, the system further comprises a monitoring device coupled to the reaction vessel and carbon feedstock container, the monitoring device operable to determine at least one characteristic of the reaction vessel and carbon feedstock container. The at least one characteristic may be selected from the group consisting of a concentration of carbon feedstock, a concentration of catalyst, velocity of feedstock, temperature of the feedstock container and/or reaction vessel, and the quantity of reaction product produced. Additionally, the monitoring device may further comprise a controller operable to change the at least one characteristic of the reaction vessel and carbon feedstock container.

In at least one embodiment of the system of the present disclosure, the system further comprises a carrier gas container containing a carrier gas, the carrier gas container operably coupled to the carbon feedstock container, wherein when the carrier gas mixes with the carbon feedstock, the mixture has an increased flow rate into the reaction vessel as compared to carbon feedstock alone.

In at least one embodiment of the system of the present disclosure, the system further comprises a filter platform sized to sealably divide the reaction vessel into an input chamber and an output chamber, the filter having at least one pore smaller than the catalyst but large enough for passage of carbon feedstock therethrough.

In at least one embodiment of the system of the present disclosure, the system further comprises a collection chamber operably connected to the output of the reaction vessel and capable of receiving the reaction product.

In at least one embodiment of the system of the present disclosure, the carbon feedstock comprises an alcohol, such as one selected from a group consisting of methanol, ethanol, butyl alcohol, and propyl alcohol.

In at least one embodiment of the system of the present disclosure, the carbon feedstock comprises a hydrocarbon having three or greater carbon atoms. Additionally, the carbon feedstock may further comprise a carrier gas in at least one embodiment of the present disclosure. Further, the carrier gas may comprise an inert gas, such as one selected from the group consisting of a noble gas, N₂, and either a noble gas or N₂ combined with one or more of CO, CO₂, H₂O, and H₂.

In at least one embodiment of the system of the present disclosure, the at least one Group VIB or Group VIIIB transition metal is selected from the group consisting of chromium, molybdenum, tungsten, iron, ruthenium, osmium, cobalt, rhodium, iridium, and a bimetallic combination thereof, such as a bimetallic combination of Fe and Co.

In at least one embodiment of the system of the present disclosure, the catalyst is supported by an inactive substrate selected from the group consisting of alumina, silica, and magnesia.

In at least one embodiment of the system of the present disclosure, the reaction vessel is structured for use with a process flow selected from the group consisting of a fluidized bed, entrained bed, raining bed, and direct injection.

In at least one embodiment of the system of the present disclosure, wherein when the system catalyzes carbon feedstock into reaction product the reaction vessel has a reaction temperature selected from the group consisting of about 400° C. to about 1200° C., about 550° C. to about 1000° C., about 600° C. to about 825° C., and about 625° C. to about 700° C. Further, in an embodiment of the system, wherein when the system catalyzes carbon feedstock into reaction product the interior of the reaction vessel has an internal pressure selected from a group consisting of about 14.7 psia to about 65 psia, about 14.7 psia to about 45 psia, about 14.7 psia to about 30 psia, and about 14.7 psia to about 20 psia.

In at least one embodiment of the system of the present disclosure, the carbon feedstock has a feedstock partial pressure selected from the group consisting of at least about 10%, at least about 20%, at least about 30%, at least about 40%, at least about 50%, at least about 60%, and at least about 70%.

In at least one embodiment of the system of the present disclosure, the coiled carbon nanotube is single walled or multi-walled. Additionally, the coiled carbon nanotube may have a coil length of about 0.05 μm to about 10 mm and a diameter of about 1 nm to about 500 nm. In an additional embodiment, the coiled carbon nanotube has a length from about 0.05 to about 10 mm or a diameter of about 1 nm to about 500 nm. Further, the reaction product of at least one embodiment of the system comprises a diamond nanoparticle.

In at least one embodiment of the system of the present disclosure, the reaction vessel is part of a fluidized bed system.

In at least one embodiment of the system of the present disclosure, wherein when the carbon feedstock is being catalyzed into reaction product, the reaction product has a carbon yield selected from the group consisting of at least about 0.1%, at least about 3%, at least about 5%, at least about 10%, and at least about 15% of the carbon feedstock per 10 second period.

In at least one embodiment of a method of producing diamond nanoparticles, the method comprises the steps of reacting a carbon feedstock and a catalyst within a reaction vessel to produce a reaction product comprising at least 1% diamond nanoparticles, wherein the carbon feedstock comprises either (i) a mixture of a hydrocarbon and water or (ii) an alcohol, and wherein the catalyst comprises at least one Group VIB or VIIIB transition metal. Optionally, the method may further comprise the step of introducing iron pentacarbonyl into the reaction vessel.

### BRIEF DESCRIPTION OF THE DRAWINGS

The above mentioned embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 shows a flowchart depicting the steps of a method of producing coiled carbon nanotubes, according to at least one embodiment of the present disclosure;

FIG. 2 shows a schematic representation of a system to produce coiled carbon nanotubes, according to at least one embodiment of the present disclosure;

FIG. 3 shows a schematic representation of a system to produce coiled carbon nanotubes, according to at least one embodiment of the present disclosure;

FIGS. 4-7 show scanning electron microscope (SEM) micrographs of coiled carbon nanotubes produced by at least one embodiment of the method of the present disclosure;

FIGS. 8-12 show transmission electron microscope (TEM) micrographs of coiled carbon nanotubes produced by at least one embodiment of the method of the present disclosure;

FIGS. 13-16 show SEM micrographs of coiled carbon nanotubes produced by at least one embodiment of the method of the present disclosure;

FIGS. 17-21 show TEM micrographs of coiled carbon nanotubes produced by at least one embodiment of the method of the present disclosure;

FIGS. 22-26 show SEM micrographs of an exemplary catalyst, according to at least one embodiment of the present disclosure;

FIGS. 27-28 show Energy-Dispersive X-Ray Spectroscopy (EDS) spectrographs of an exemplary catalyst visualized in FIG. 26;

FIGS. 29-32 show SEM micrographs of diamond nanoparticles produced by at least one embodiment of the method of the present disclosure; and

FIGS. 33-37 show TEM micrographs of diamond nanoparticles produced by at least one embodiment of the method of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

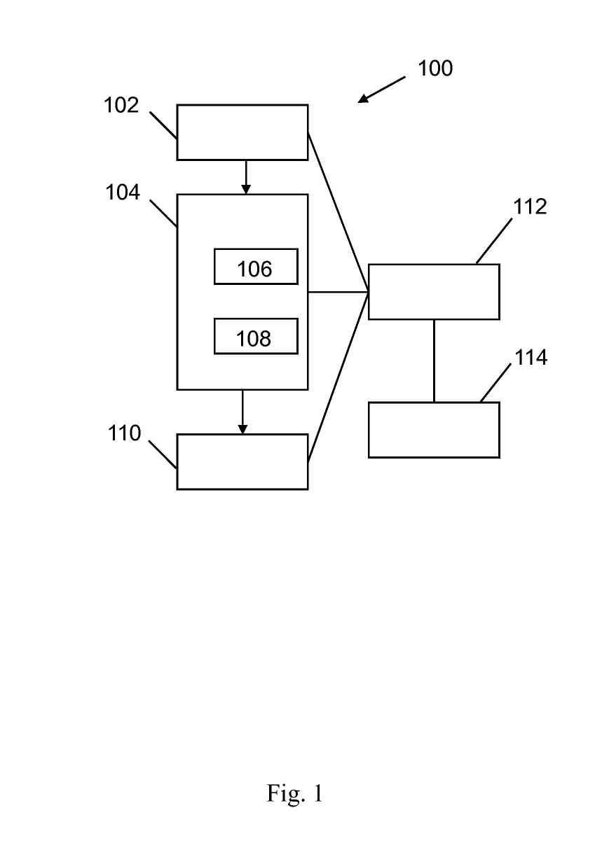

The disclosure of the present application provides various methods and systems for producing coiled carbon nanotubes and diamond nanoparticles. An exemplary method for producing coiled carbon nanotubes of the present disclosure is shown in FIG. 1. Exemplary method 100 comprises the steps of introducing a carbon feedstock and catalyst capable of catalyzing the carbon feedstock into a coiled carbon nanotube into a reaction vessel (exemplary introducing step 102), and reacting the carbon feedstock with the catalyst in the reaction vessel to produce a reaction product comprising a coiled carbon nanotube (exemplary reacting step 104).

An exemplary carbon feedstock used in at least one method or system of producing coiled carbon nanotubes of the present disclosure may comprise a hydrocarbon or an alcohol. Specifically, an exemplary carbon feedstock may comprise a methyl-, ethyl-, butyl-, or propyl-alcohol or a methyl-, ethyl-, butyl-, or propyl-hydrocarbon in combination with water. At least one exemplary carbon feedstock may comprise ethanol or another ethyl-hydrocarbon(ethylene or ethane) in combination with water and hydrogen gas. The hydroxyl groups on the alcohol or water in combination with a hydrocarbon may act in at least one embodiment of the method of the present disclosure to 1) clean the product of the method of the present disclosure of amorphous carbon and defects and 2) reactivate the catalyst during the reacting step 104.

The catalyst of the present disclosure may comprise a metal such as a Group VIB or VIIIB transition metal. In an exemplary embodiment, the metal may be selected from the group consisting of chromium, molybdenum, tungsten, iron, ruthenium, osmium, cobalt, rhodium, iridium, and a bimetallic combination thereof. In at least one embodiment of the catalyst of the present disclosure, the catalyst may comprise one or more of iron, cobalt, and molybdenum. Further, an exemplary catalyst of the present disclosure may be a bimetallic iron-cobalt catalyst.

Introduction of carbon feedstock into the reaction vessel in step 102 of an exemplary method 100 may also occur at a defined partial pressure. For instance, the partial pressure may be selected from about 10% to about 70%, from about 20% to about 60%, from about 35% to about 55%, and at about 50%.

In at least one exemplary embodiment of the method of the present disclosure, a carrier gas may be included to facilitate the flow of materials, such as a carbon feedstock, into and through the reaction vessel. An exemplary carrier gas of the present disclosure may comprise an inert gas. For instance, an exemplary carrier gas may comprise a noble gas or nitrogen gas. If in an embodiment of the method of producing coiled carbon nanotubes of the present disclosure, no carrier gas is used, the feedstock partial pressure would in effect be 100% and the overall reaction pressure (as described in further detail herein) may be scaled down to accommodate desired reaction kinetics.

The catalyst of the present disclosure may also be supported on an inactive substrate (e.g., alumina, silica or magnesia, etc.), floated (e.g., iron pentacarbonyl), or solid. Supporting, floating, or solidly attaching the catalyst may act to increase surface area of the catalyst, in at least one embodiment of the present disclosure. Further, the size of the catalytic sites used in the present disclosure may act to control the diameter of the reaction product generated during reacting step 104 and may be adjusted as desired. Such catalytic sites of exemplary catalysts may range from 1-2 nanometers to 600+ nanometers. Depending on the catalytic site, various single walled nanotube or small diameter multi-walled nanotubes may be generated. Larger catalytic sites may generate large diameter multi-walled nanotubes in various embodiments of methods of the present disclosure.

An exemplary reacting step 104 of method 100 may be carried out using any number of applicable process flows. For instance, the process flow of reacting step 104 may be carried out utilizing a continuous process flow such as a fluidized bed, entrained bed, raining bed or direct injection process flow.

An exemplary reacting step 104 may further comprise the step of heating the reaction vessel to a reaction temperature (exemplary heating step 106). Further, the reacting step 104 may additionally comprise the step of pressurizing the interior of the reaction vessel to a reaction pressure (exemplary pressurizing step 108). In at least one embodiment of method 100, the reaction temperature of heating step 106 may be from about 550° to about 1000° C., from about 600° to about 825° C., or from about 625° to about 700° C. Additionally, the reaction pressure developed in the reaction vessel during pressurizing step 108 may be at or above atmospheric pressure. Specifically, in an exemplary embodiment of step 108, the pressure may be selected from a group consisting of about 14.7 to about 45 psia, about 14.7 to about 30 psia, and from about 14.7 to about 20 psia.

In an exemplary embodiment of method 100, reacting step 104 may have an overall reaction flow rate and feedstock velocity. An exemplary reacting step 104 may produce an overall reaction flow rate selected from about 5 to about 40 liters per minute (LPM), from about 10 to about 30 LPM, or from 15-20 LPM. Further, in at least one embodiment of the reacting step 104, the overall reaction flow rate can be demonstrated through a quartz tube with an inner diameter of about 101.6 mm and a heated length of about 400 mm; resulting in a reaction zone volume of approximately 3.24 L. The resulting velocity of the feedstock and carrier gas mixture entering the reaction zone can be selected from about 0.62 to about 4.94 meters/minute, from about 1.23 to about 3.70 meters/minute, and from about 1.85 to about 2.47 meters/minute.

In an exemplary embodiment of method 100, the reaction vessel can also have a catalyst load, where the catalyst load is defined as the relative magnitude of catalytic sites available for the carbon feedstock to react. Specifically, the catalyst load may be determined by the amount of catalyst loaded into the reaction vessel.

The catalytic load may also indirectly affect the length of the coiled carbon nanotube of reacting step 104 in the sense that when fewer catalytic sites are available to a given amount of feedstock, the product that grows on these sites will be relatively longer than product grown on a larger number of catalytic sites from the same amount of feedstock.

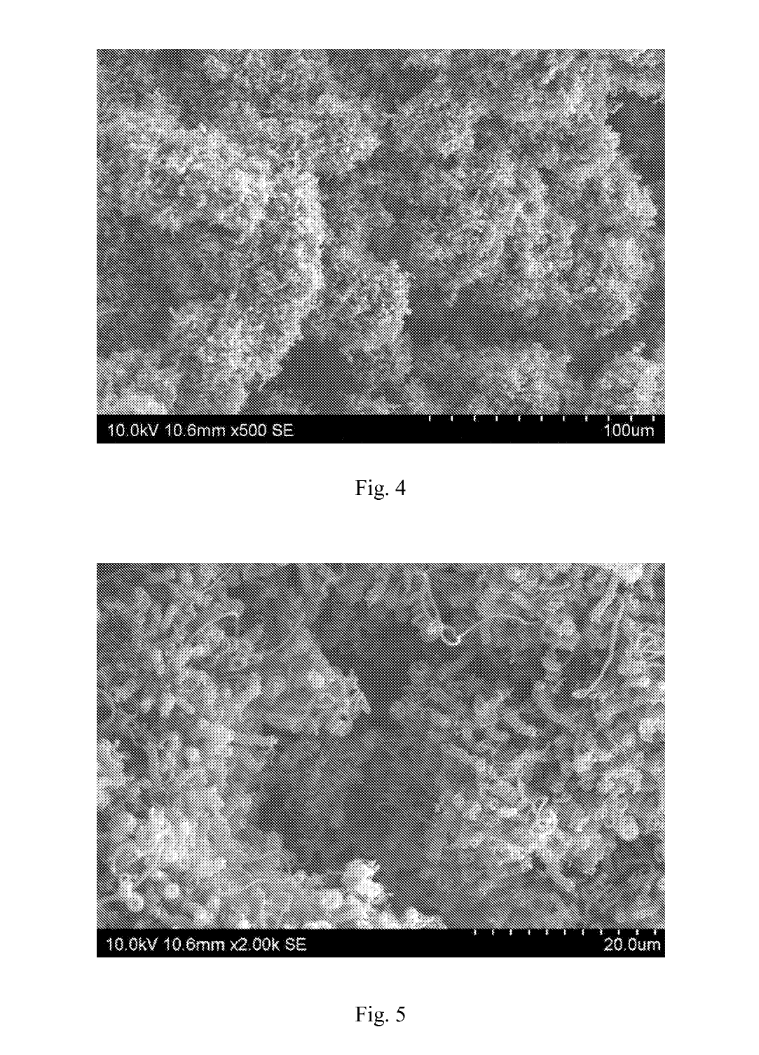

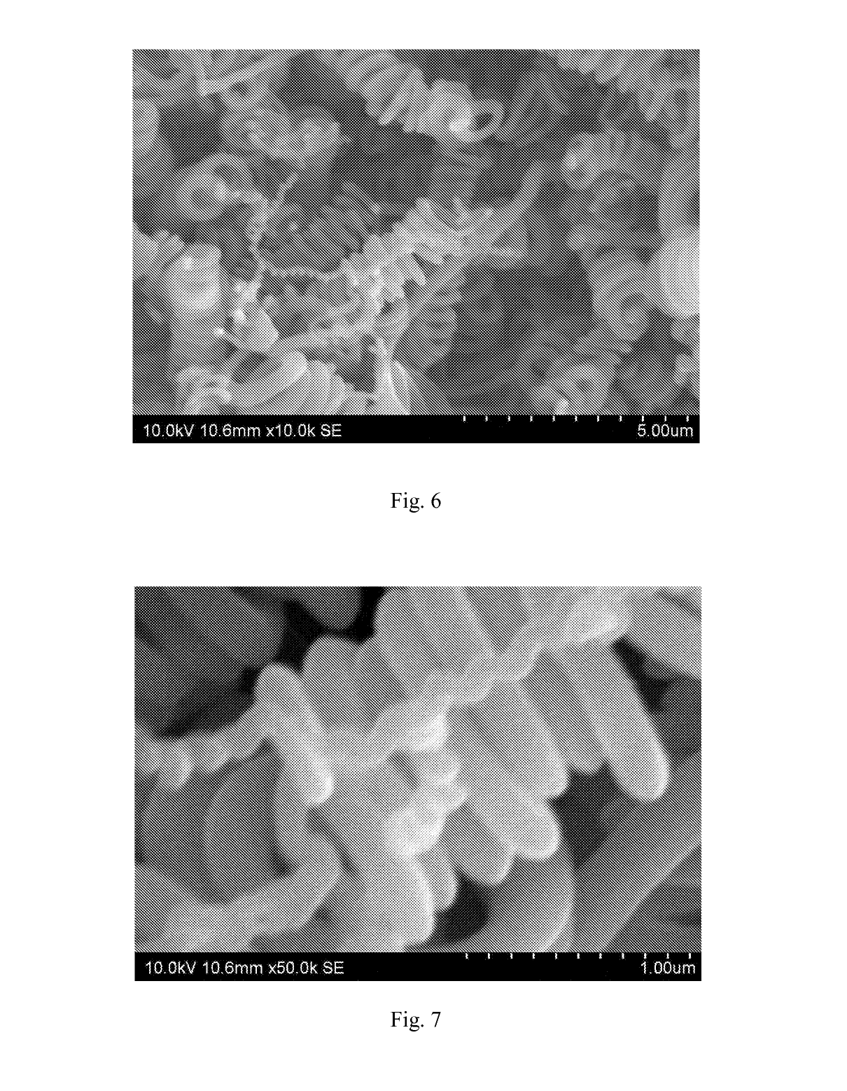

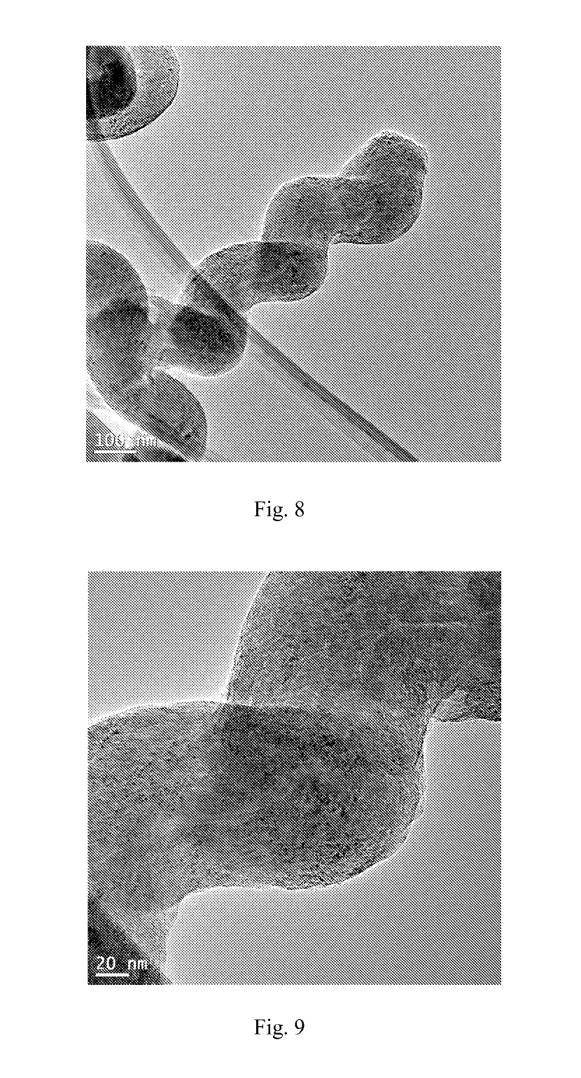

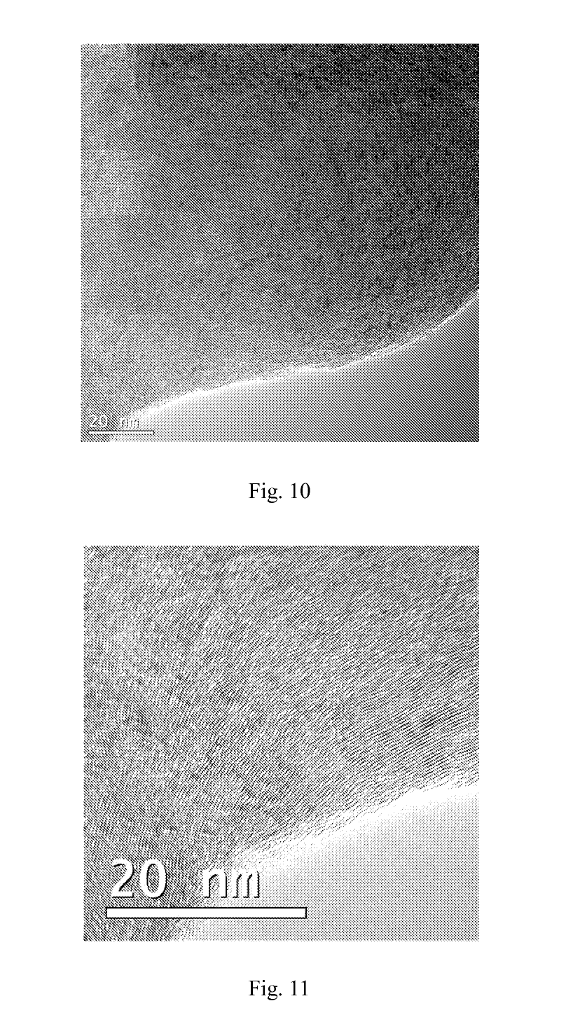

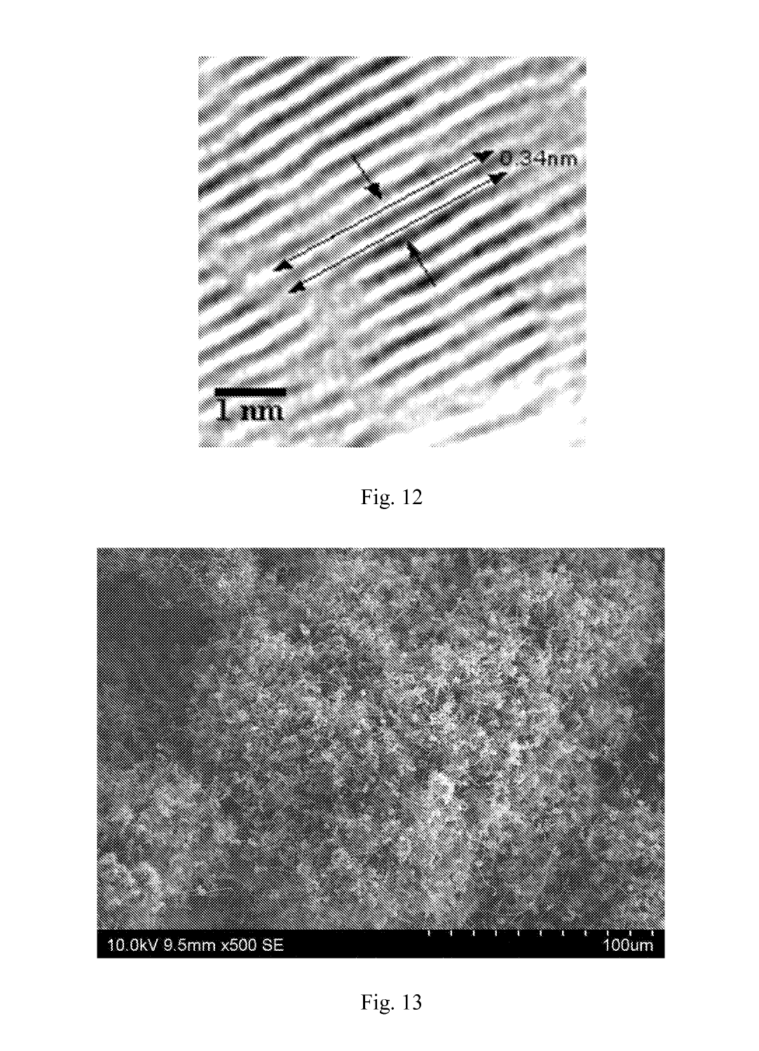

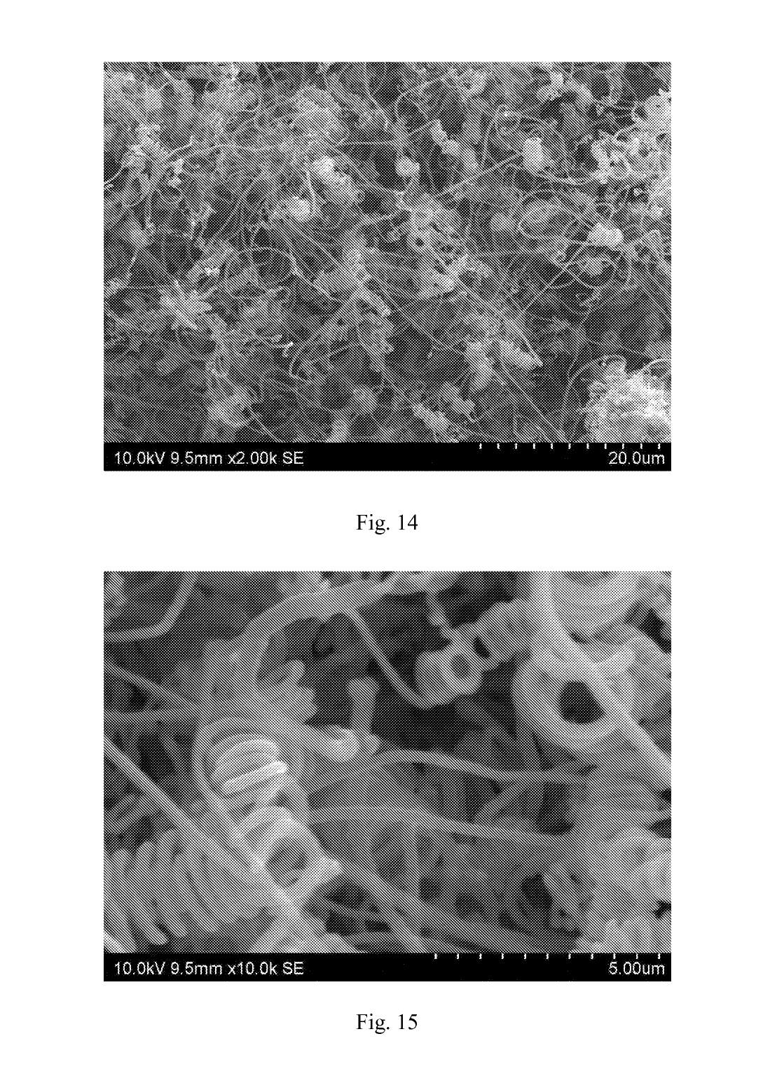

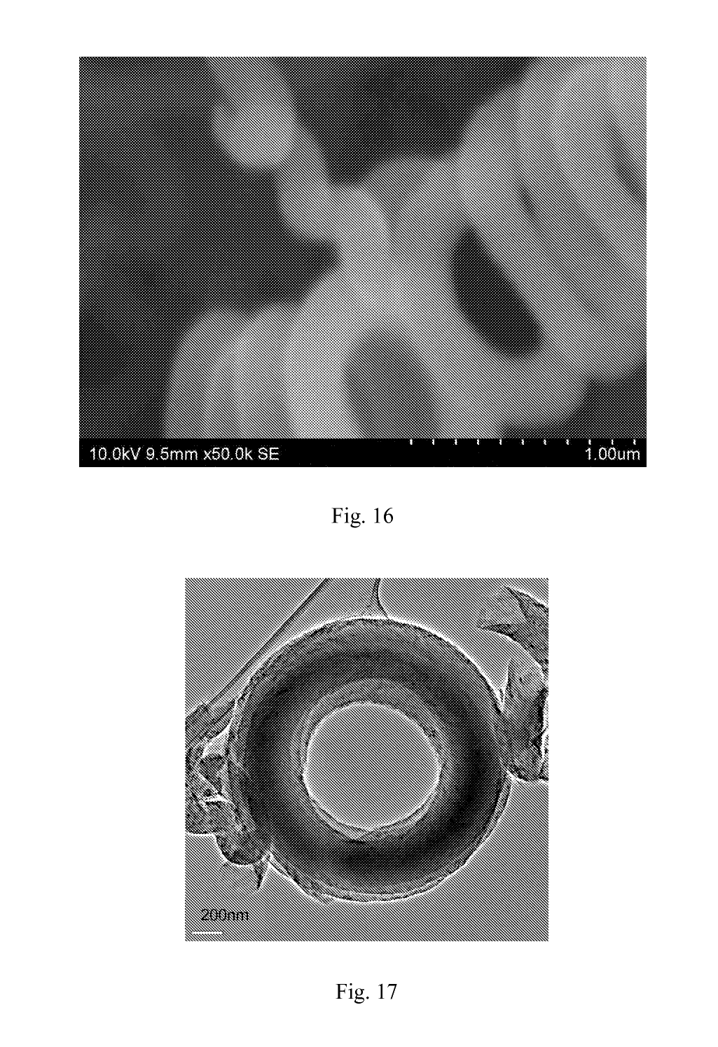

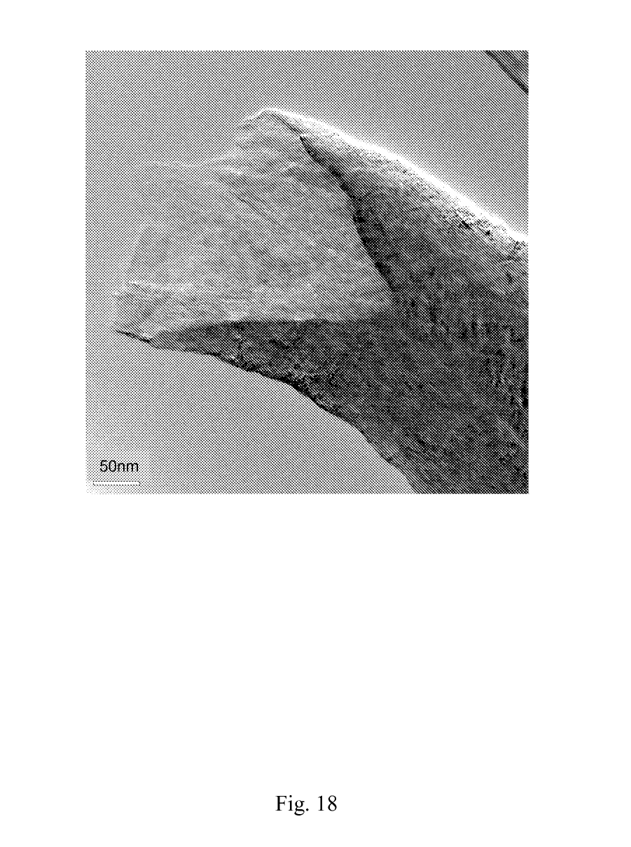

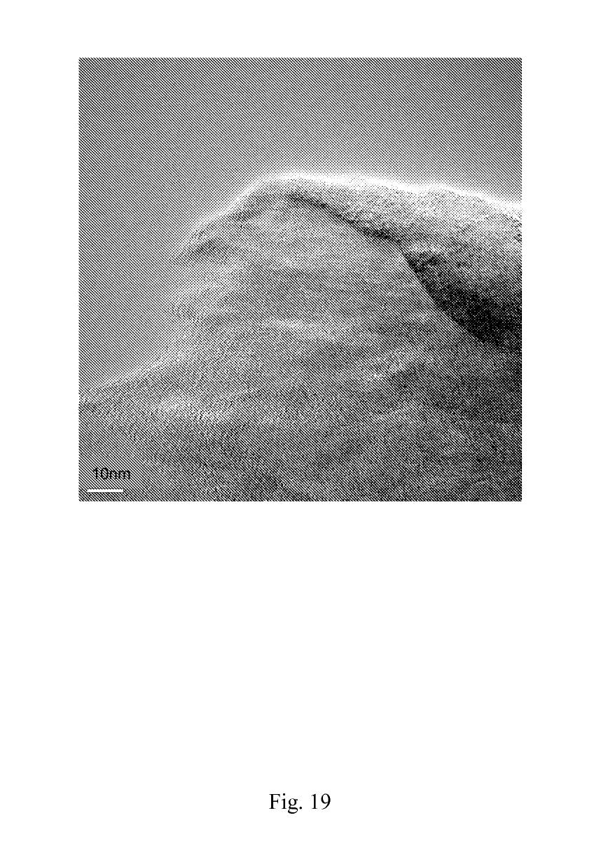

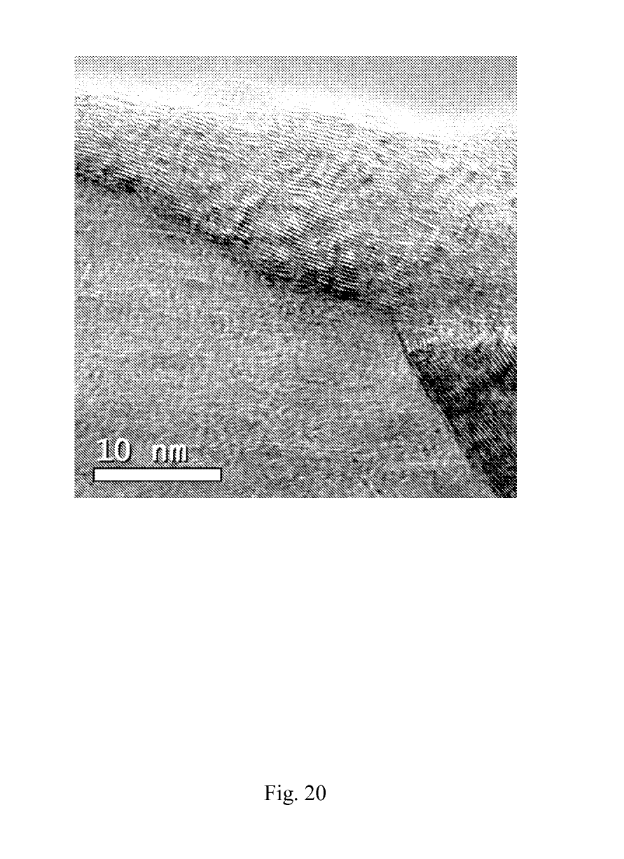

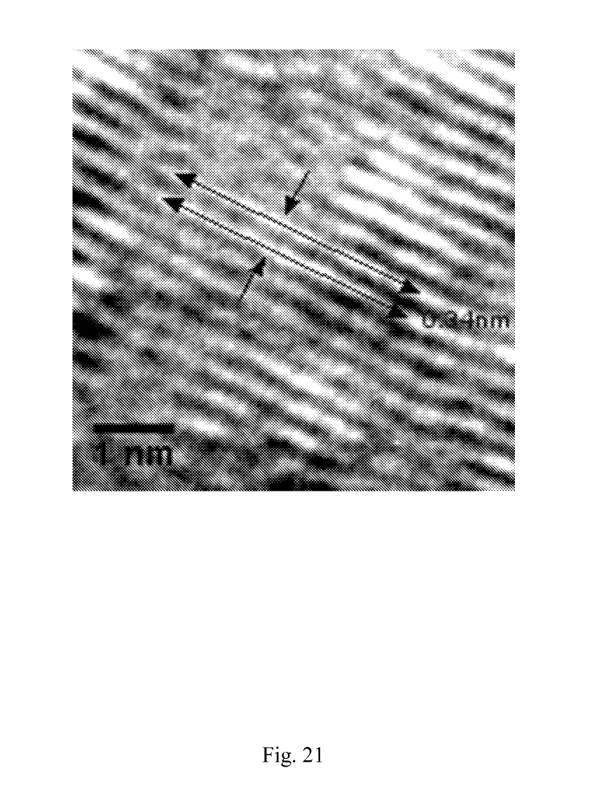

When sufficient catalyst is present in reacting step 104 of exemplary method 100, the reaction product comprises a high concentration of regularly coiled carbon nanotube structures relatively free from amorphous carbon as depicted in FIGS. 4 through 21. In FIGS. 12 and 21, the product was confirmed to be composed of wrapped graphene layers through the measurement of atomic interplanar spacing of 0.34 nm (consistent with multi-walled coiled carbon nanotubes). Additionally, the diameter of the reaction product may be controlled by the size of the catalyst active sites, and the length of the reaction product may be controlled by the reaction duration. An embodiment of product produced by an exemplary method 100 of the present disclosure with a reaction duration of 24 minutes and an Fe catalyst yielded product with a coiled length of 5(+/−1) microns and diameter ranging from 20 to +400 nm.

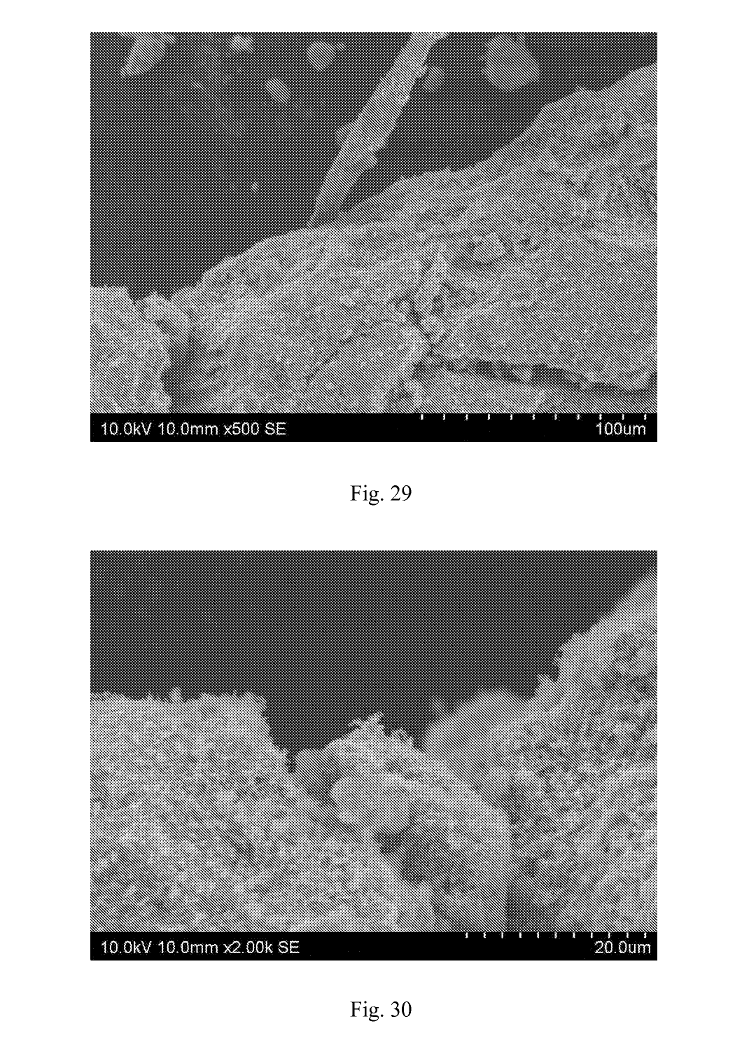

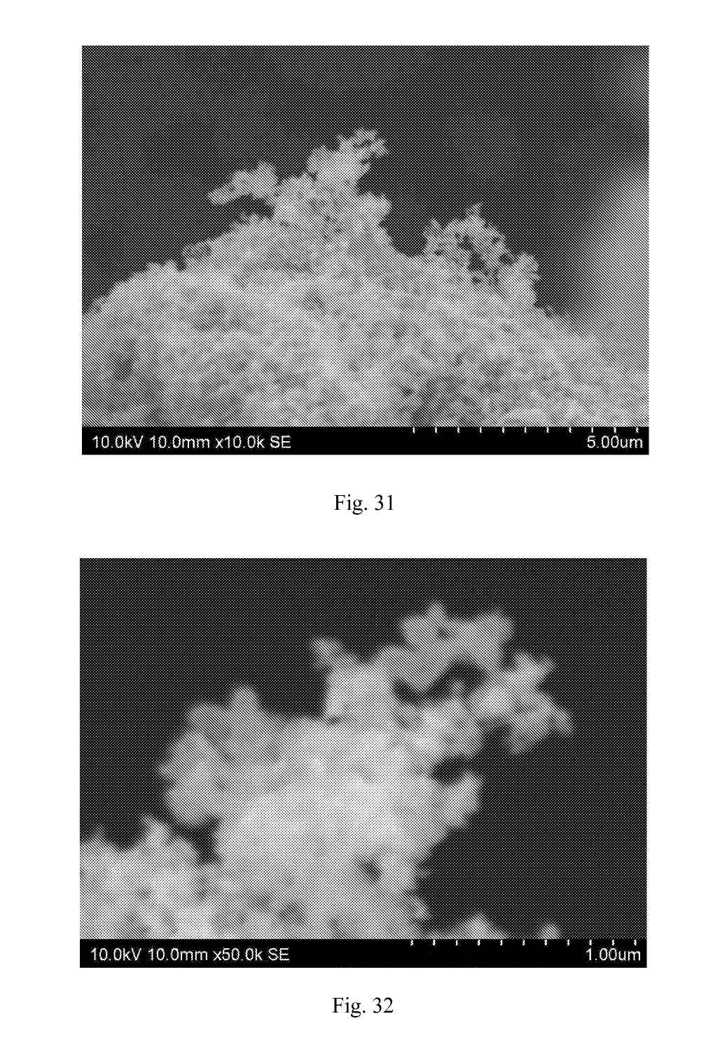

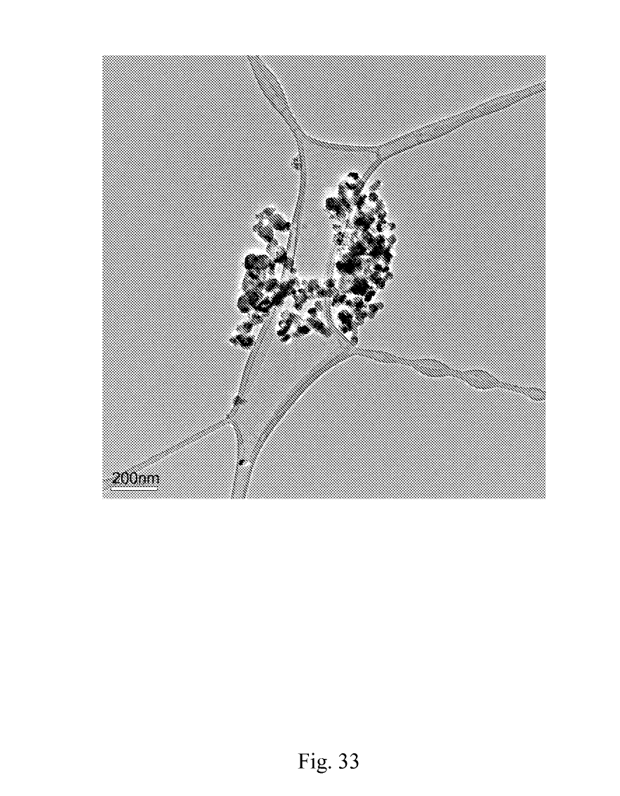

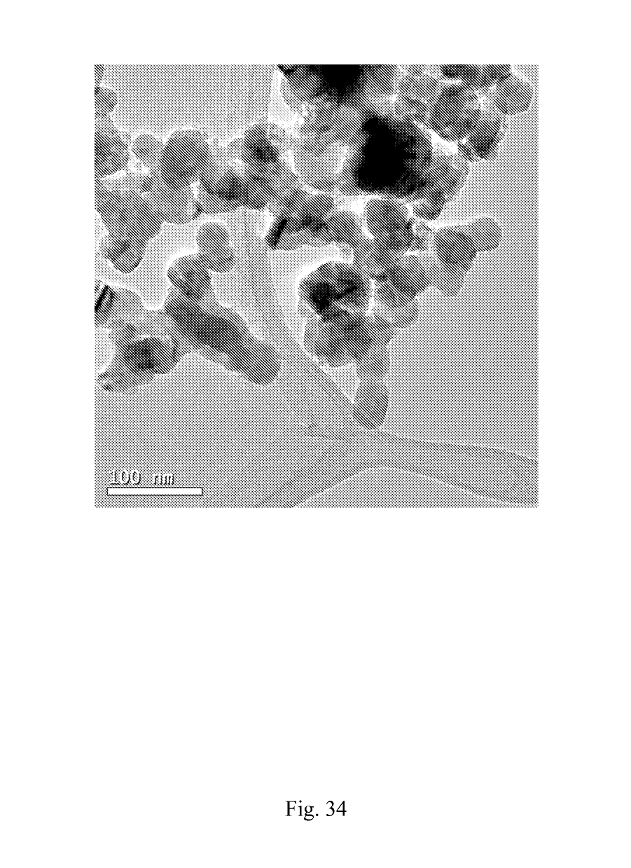

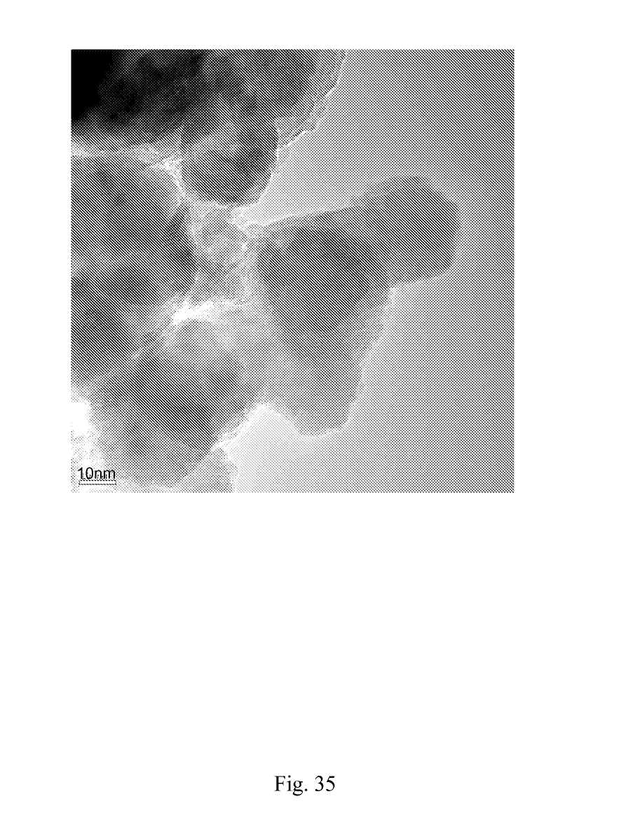

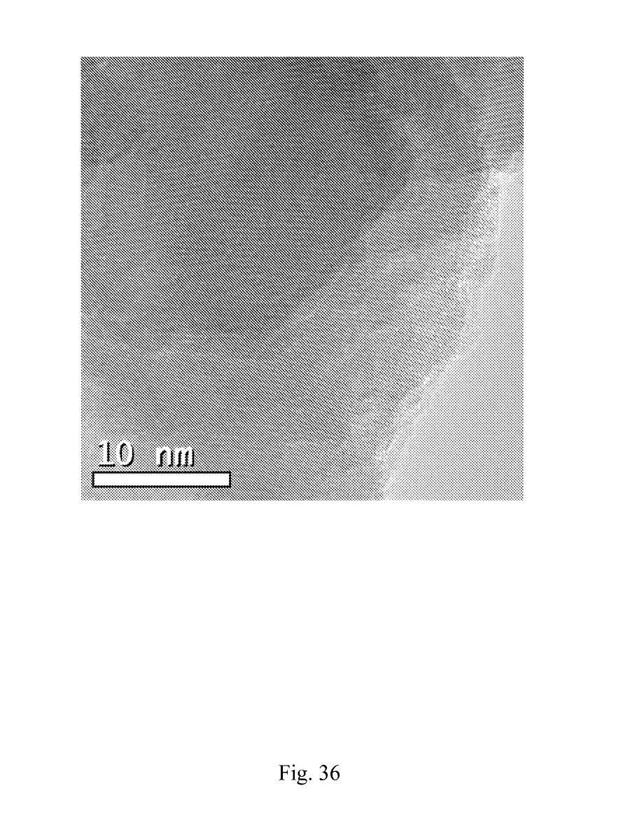

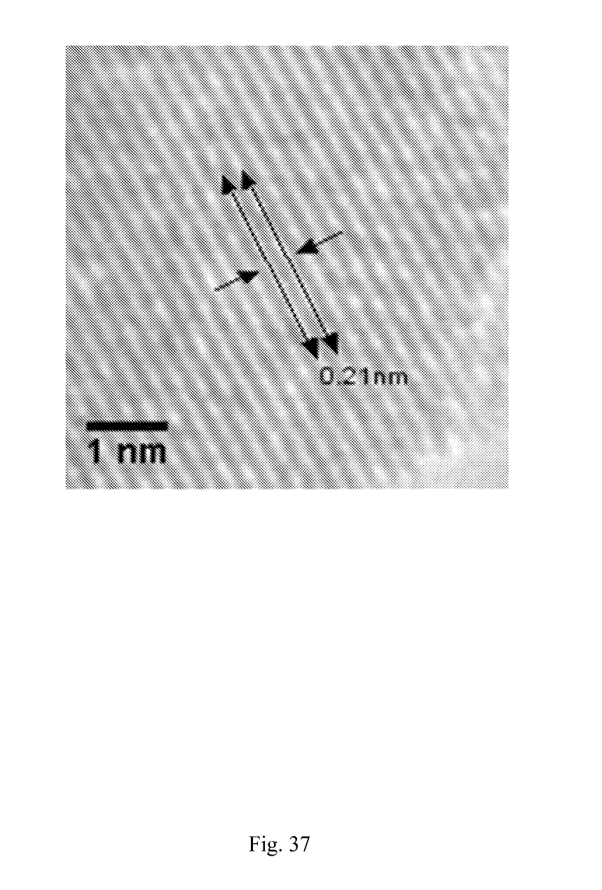

In an embodiment of method 100 where the catalyst is withheld or restricted, the reaction product of reacting step 104 is comprised of diamond nanoparticles ranging in size from 20-80 nm as depicted in FIGS. 29-37. In FIG. 37, the product is confirmed to be composed of the diamond allotrope of carbon by measuring the interplanar spacing of 0.21 nm; consistent with (111) diamond. To increase the yields of diamond nanoparticles in an embodiment of method 100, it is possible to seed the reaction with a restricted amount (about 1% to about 0.5% partial pressure) of iron pentacarbonyl catalyst.

At least some embodiments of method 100 of the present disclosure give carbon yields from carbon feedstock entering the reaction to carbon containing product in the range of about 0.1 to about 15% for every 9-11 seconds the feedstock is exposed to reaction conditions. Additionally, carbon yields may be in the range of about 3% to about 15% for every 10 seconds of reaction time, or about 10% to about 15% for every 10 seconds the feedstock is in the reaction zone.

To increase carbon yields in embodiments of the method 100 of the present disclosure, the reaction zone of the reaction vessel may be lengthened while maintaining the same reaction kinetics to increase the time the feedstock is exposed to reaction conditions. Through increasing the time the feedstock is in the reaction zone, the carbon conversion rate from feedstock to product may exceed 40%, which has been demonstrated as a limit in no flow fixed bed alcohol catalytic chemical vapor deposition reactions due to catalyst poisoning and the limits of diffusion in a no flow system. For at least one embodiment of method 100 of the present disclosure, the reaction zone may be lengthened to achieve carbon conversion efficiencies approaching complete conversion.

The duration of exemplary reacting step 104 of an embodiment of method 100 may be defined as the amount of time the reaction product is allowed to grow. This duration can directly control the length of the reaction product and in chemical vapor deposition processes, is generally limited by the amount of time the catalyst remains active. In embodiments of the present disclosure the catalyst may be reactivated in situ by water vapor generated as a decomposition product of the feedstock or added with the feedstock. Therefore, the reaction duration can be extended or shortened to achieve the desired length of fullerene product. Additional water vapor may also be added to the reaction vessel to reactivate catalyst when attempting to achieve long duration reactions. These durations may range from the initiation of the reaction to 24 hours, from the initiation of the reaction to 12 hours, from the initiation of the reaction to 6 hours, from the initiation of the reaction to 3 hours, from the initiation of the reaction to 2 hours, from the initiation of the reaction to 1 hours, from the initiation of the reaction to 45 minutes, from the initiation of the reaction to about 24 minutes, from the initiation of the reaction to about 12 minutes, and from the initiation of the reaction to about 6 minutes.

Exemplary method 100 may further comprise the step of collecting the reaction product of reaction step 104 (exemplary collecting step 110). An exemplary collecting step 110 may occur through any appropriate method, such as filtration of the outflow of reaction product from the reaction vessel.

Further, method 100 may also comprise the step of monitoring the reaction variables of method 100 with a monitoring device (exemplary monitoring step 112). The monitoring device is operably coupled to one or more of the components used in method 100. The reaction variables monitored may include one or more of the concentration of carbon feedstock, carrier gas and catalyst, the velocity of feedstock and/or carrier gas, the temperature of the chambers and/or reaction vessel, and the quantity of reaction product collected.

An exemplary method 100 may further comprise the step of controlling the reaction variables of method 100 to change the type or quantity of reaction product produced (exemplary controlling step 114). To accomplish an exemplary controlling step 114, an embodiment of a controller operable to receive input from the monitoring device and effective to alter at least one reaction variable is coupled to the monitoring device. An exemplary embodiment of the controller may also be capable of human and/or electronic input to modify the reaction variables.

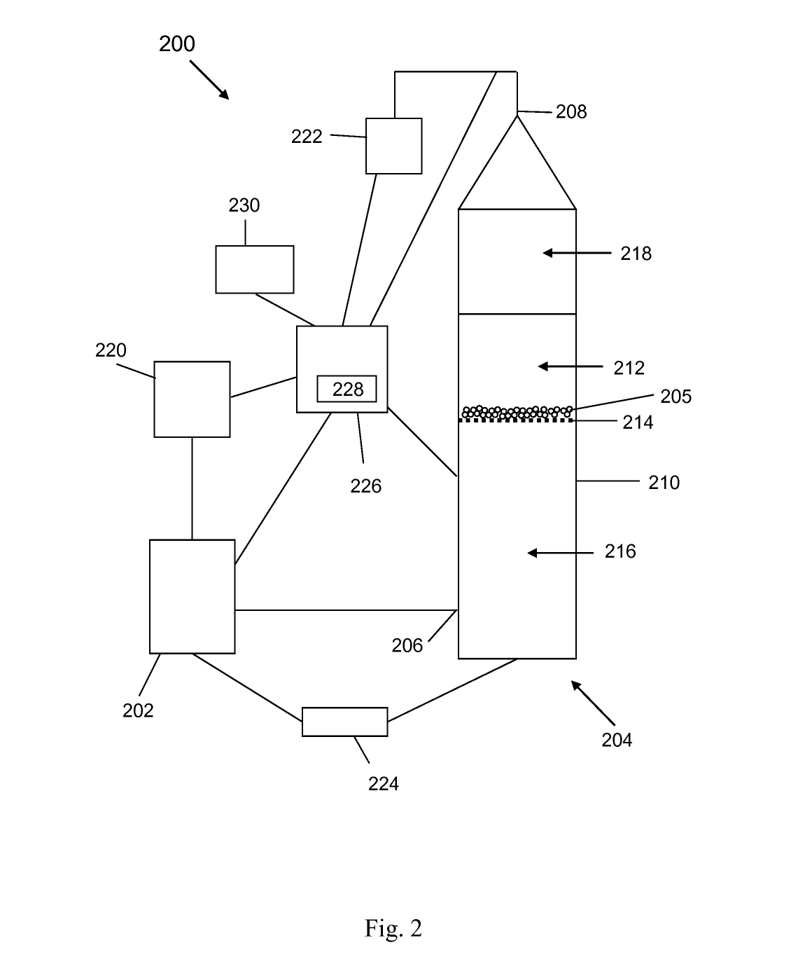

Turning to FIG. 2, a schematic of an exemplary system for producing coiled carbon nanotubes or diamond nanoparticles is shown. The exemplary system 200 is comprised of a feedstock container 202 capable of containing an embodiment of a carbon feedstock and a reaction vessel 204 capable of containing an embodiment of a catalyst 205. Exemplary reaction vessel 204 comprises an input 206, an output 208, and a vessel 210 capable of housing an embodiment of a catalyst 205. The feedstock container 202 being operably connected to the input 206 of the reaction vessel 204, and allowing the carbon feedstock to flow from the feedstock container 202 to the vessel 210.

In at least one embodiment of vessel 210, the vessel may contain a reaction zone 212 where the carbon feedstock flowing from feedstock container 202 through input 206 and into reaction zone 212 is contacted with an embodiment of the catalyst. Additionally, reaction zone 212 may also comprise a filter platform 214 having at least one pore smaller than the catalyst. The at least one pore being sized to allow carbon feedstock to pass therethrough, but not permitting passage of catalyst or reaction product. The exemplary filter platform 214 is sized and shaped to seal the vessel 210 into an input compartment 216 and an output compartment 218. The input compartment 216 coupled to input 206, and the output compartment coupled to output 208. Further, in at least one embodiment, the catalyst is located in the output compartment 218.

Further, exemplary system 200 may also comprise a carrier container 220 operable to house an exemplary carrier gas capable of increasing the flow of carbon feedstock from feedstock container 202 into the reaction vessel 204. The carrier container 220 may be operably connected to feedstock container 202, and capable of mixing carrier gas with carbon feedstock.

Additionally, an exemplary system 200 may further comprise a collection chamber 222 operably connected to the outlet 208 of reaction vessel 204. An exemplary collection chamber 222 is capable of collecting coiled carbon nanotubes produced in the reaction vessel 204 and flowing through outlet 208.

Accordingly, in at least one embodiment, system 200 is structured such that carbon feedstock may flow from feedstock container 202 through input 206 and into input compartment 216 of vessel 210. From that point, the exemplary carbon feedstock may flow through filter platform 214 and contact the exemplary catalyst in the reaction zone 212 of output compartment 218. The reaction product of the contact between the carbon feedstock and the catalyst may then flow through the output 208 and into collection chamber 222.

At least one embodiment of system 200 may additionally comprise a temperature control device 224 operably coupled to one or both of feedstock container 202 and vessel 204. The temperature control device 224 may be able to alter the temperature within at least part of the system 200 to control the reaction rate of the production of coiled carbon nanotubes. Further, temperature control device is operable to produce and maintain an embodiment of the reaction temperature within the desired component of system 200.

In at least one exemplary embodiment of system 200, the system may further comprise one or more monitoring device 226 operably coupled to one or more of the feedstock container 202, vessel 204, carrier container 220, and collection chamber 222. The monitoring device 226 in at least one embodiment is capable of measuring at least one condition of the reaction within system 200. For instance, the monitoring device 226 may be able to measure temperature, pressure, content of carrier gas, carbon feedstock within the reaction vessel, and the amount of coiled nanotubes produced and/or collected in collection chamber 222.

Monitoring device 226, in an exemplary embodiment, may further comprise a controller 228 operable to alter at least one of the conditions measured by monitoring device 226. Further, monitoring device 226 may also be operably connected to an external input 230 capable of causing controller 228 to alter at least one condition of the reaction within system 200. An exemplary external input 230 may comprise a secondary processor or manual input for a user. Additionally, controller 228 and/or external input 230 may further be operable to store the at least one condition of the reaction measured by monitoring device 226.

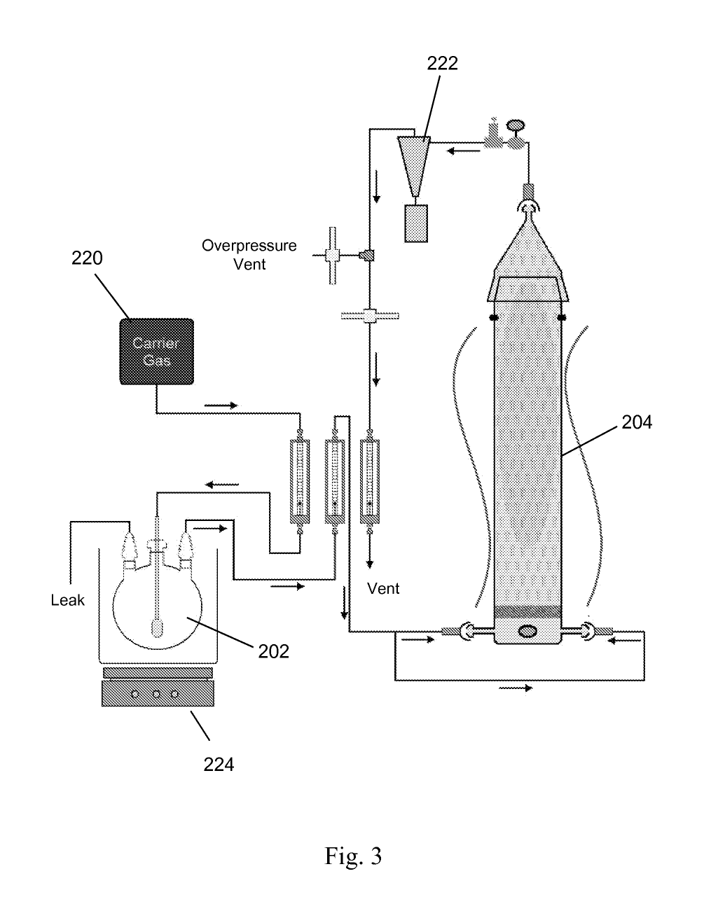

Turning to FIG. 3, at least one embodiment of system 200 of the present disclosure is depicted. The diagram shows one possible process flow of the present disclosure in the following order: (1) carrier gas from carrier chamber 220 is introduced to a carbon feedstock held in feedstock container 202, which may be temperature regulated by temperature control device 224 to control the feedstock partial pressure; (2) vapor from the carbon feedstock/carrier gas mixture is introduced into the reaction vessel 204 at a specified velocity; (3) the feedstock/carrier gas mixture flows up through a preloaded catalyst in the temperature and pressure controlled vessel 204; (4) product forms in the temperature and pressure controlled vessel 204; (5) product collects on the vessel walls and/or vents from the vessel and is collected by various filtration methods in the collection chamber 222.

### Example Catalyst Preparation

At least one embodiment of the preparation of catalyst for use in an embodiment of method 100 or system 200 includes the steps of:
1) Placing about 500 grams Iron (5 micron carbonyl) powder (99.9% pure) into a container;
2) Adding about 15.85 grams Cobalt (II) Acetate Tetrahydrate to about 200 ml ethanol to a separate container, and allowing it to dissolve;
3) Once the cobalt-ethanol solution is prepared, pour the cobalt-ethanol solution onto the iron powder;
4) Mix for about 5 minutes, such as for example with a high shear blender;
5) Remove the ethanol from product by means such as filtration and wash the filtered product with a solvent such as acetone;
6) Place powdered catalyst in furnace at about 200° C. overnight or at least about 6 hours; and
7) Take heated catalyst out of furnace and place in sealed desiccators until use.

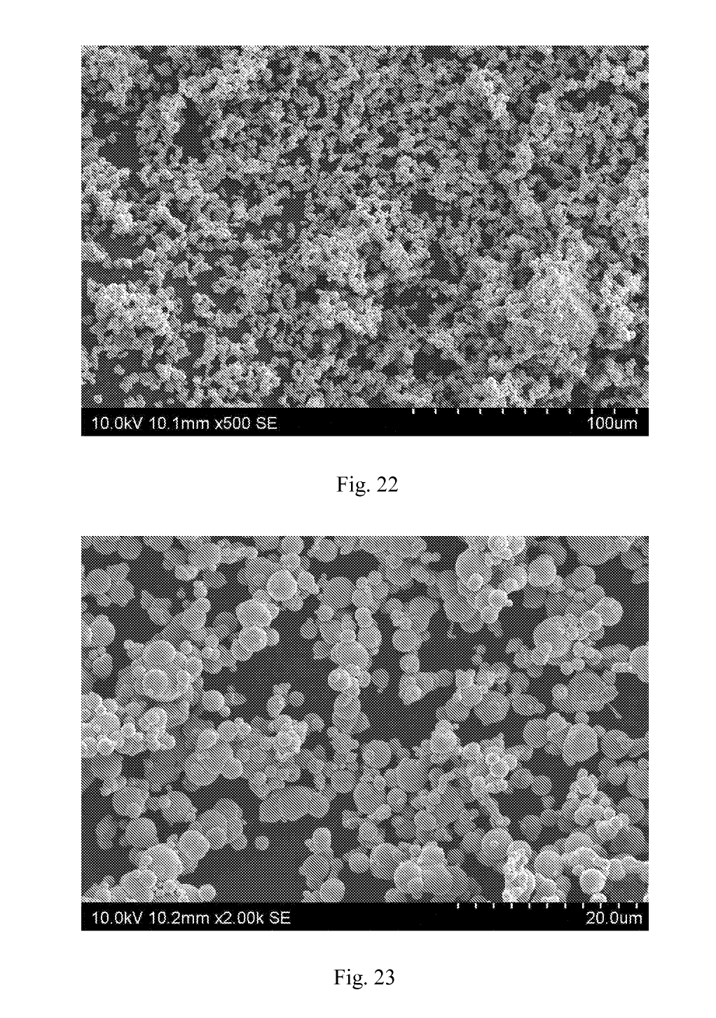

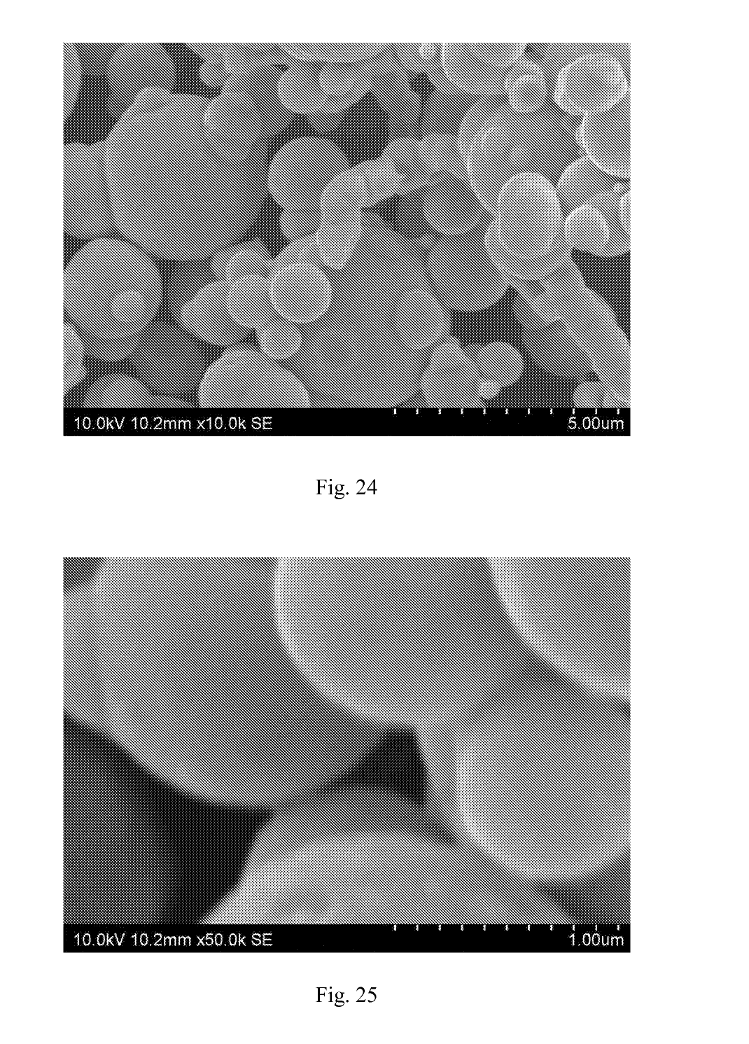

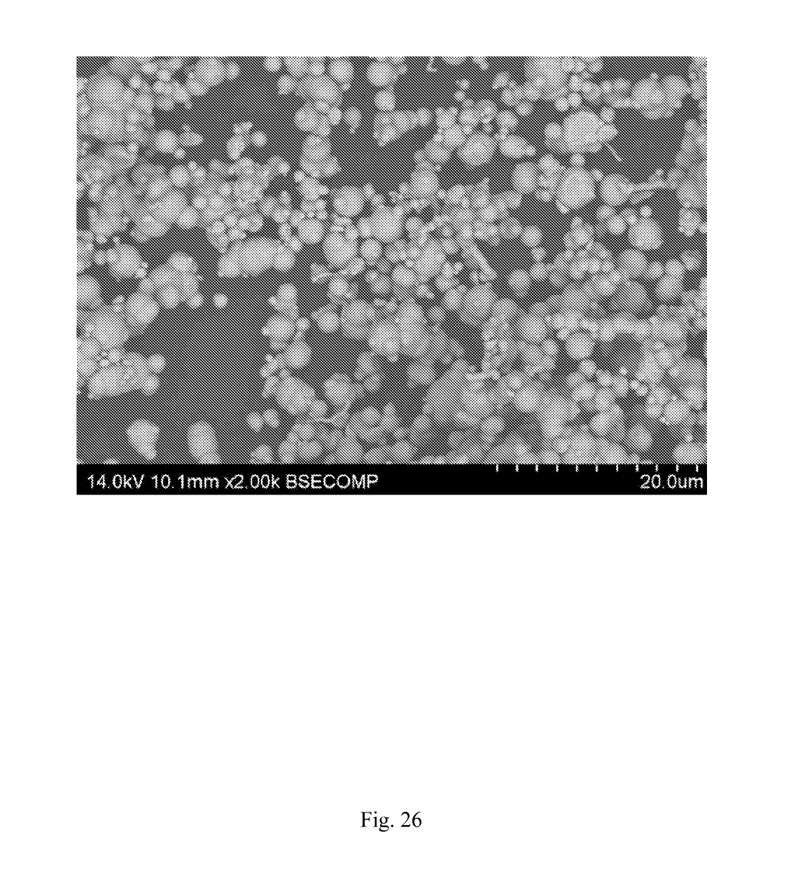

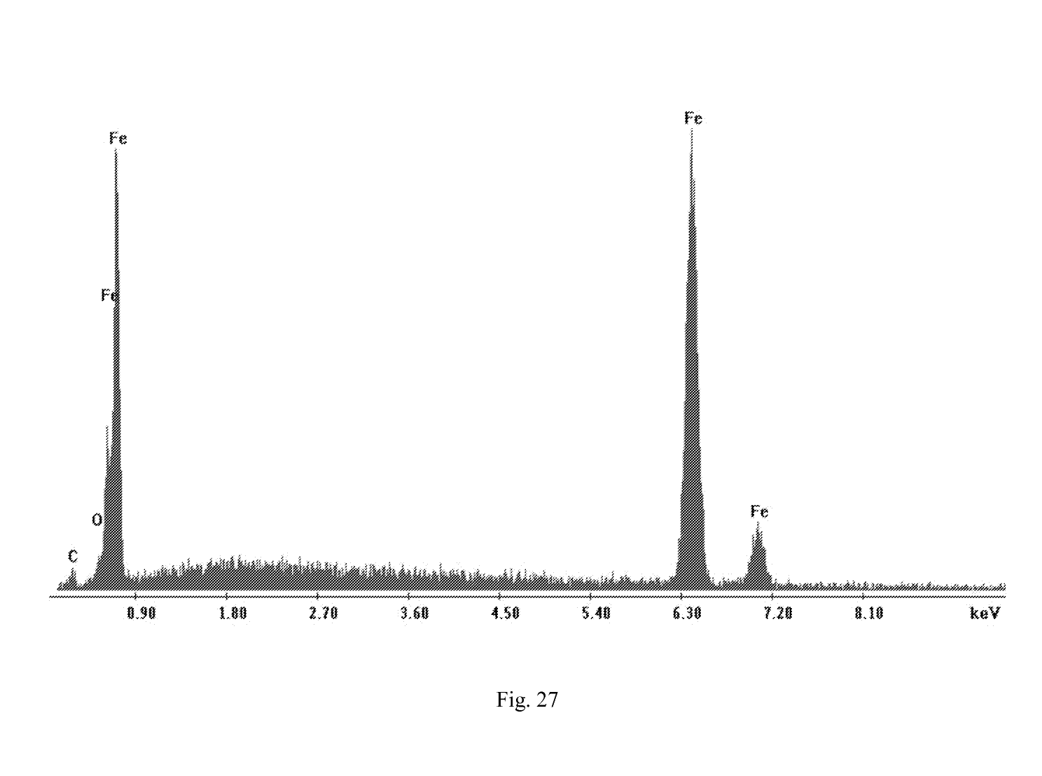

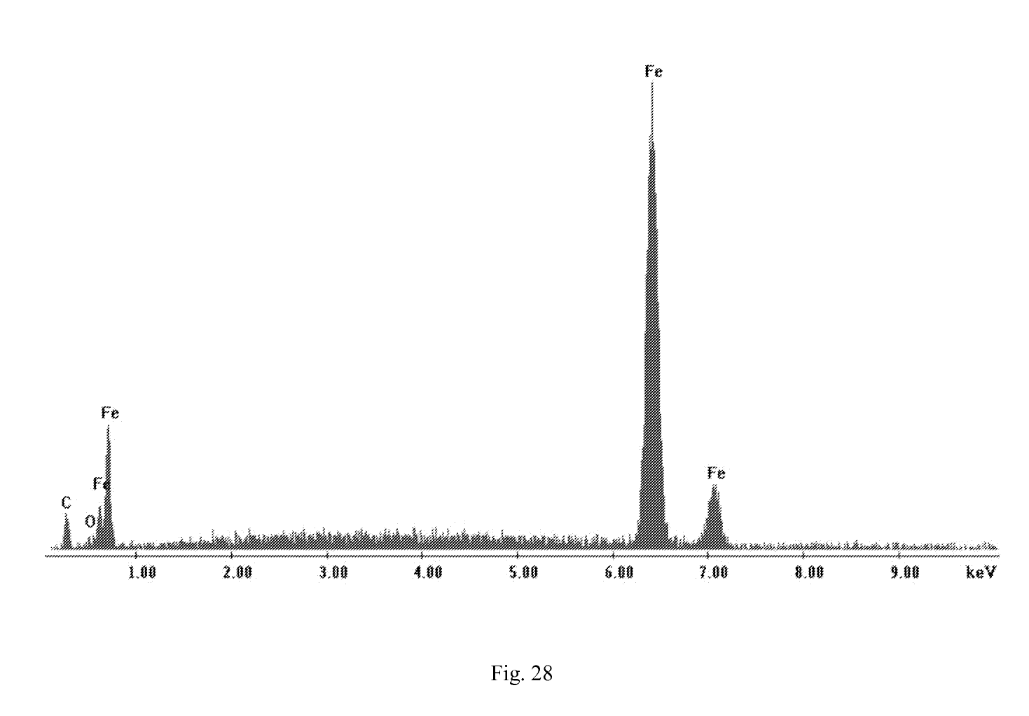

Characterization of an exemplary embodiment of the catalyst produced by the catalyst preparation may be seen in FIGS. 22-28. FIGS. 22-26 visualize the catalyst through scanning electron microscopy (SEM), with FIG. 26 visualizing the catalyst through back scattering SEM. Through using the back scattering mode of SEM, the embodiment the catalyst visualized in FIG. 26 was shown to be composed substantially of the same element, due to the same relative back scatter intensity of the catalyst visualized. To further analyze the chemical composition of the embodiment of the catalyst visualized in FIG. 26, energy-dispersive X-ray spectroscopy (EDS) were performed on the sample used for FIG. 26. FIGS. 27 and 28 show the spectrographs obtained through EDS of these samples. In the analysis of the embodiment of the catalyst shown in FIGS. 27 and 28, cobalt was not detected, and is presumed to have been removed during the wash step (see Step 5). Additional embodiments of the catalyst preparation serve to produce a bimetallic catalyst of Iron and Cobalt.

While various embodiments of methods and systems for producing coiled carbon nanotubes and diamond nanoparticles have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

### Analytical Methods:

Scanning Electron Microscopy (SEM): The included figures labeled as SEM micrographs and EDS spectrographs were generated using a Hitachi S-3400N scanning electron microscope. The samples were prepared by taking reaction product of the present disclosure and sprinkling it on carbon tape fixed to an SEM pedestal. The pedestal was slightly shaken (tapped) to remove excess product and then inserted into the SEM for analysis.

Transmission Electron Microscopy (TEM): The included figures labeled as TEM micrographs were generated using a JEOL JEM 3200FS transmission electron microscope. The samples were prepared by taking as-produced product of the present disclosure, grinding the reaction product in a mortar and pestle to ensure uniformity, adding ½ ml methanol to the mortar to suspend the sample powder, depositing 5 μL of the product/methanol suspension onto an empty TEM matrix with a syringe, wicking off excess moisture and product with filter paper, air drying the TEM grid, inserting the grid into the TEM for analysis.

### EXAMPLES

Details of exemplary embodiments of methods for producing coiled carbon nanotubes are described herein. Example 1 used 50 g of catalyst, example 2 used 5 grams of catalyst, and example 3 used a constant 0.80% partial pressure of iron pentacarbonyl; each example has the +/−2.99 grams (0.065 moles) of feedstock available at a given time.

### Example Process Flow

One possible process flow used in certain exemplary methods of the present disclosure is a vertical fluidized bed reaction system. A partial diagram of such a fluidized bed system is given in FIG. 3. This exemplary system utilized various mechanisms to control the reaction specifications and conditions of the present disclosure; but the embodiments of systems or methods of the present disclosure are not limited to these specified mechanisms or process flow. A description of the various control mechanisms that comprise this example of a Process Flow is given below.

To control the carrier gas type and reaction kinetics, the exemplary embodiment utilizes a nitrogen gas generator (Peak Scientific Instruments NM20Z) connected to a clean compressed air line. The velocity of the carrier gas (flowing from the generator) is measured with a rotameter as it is introduced into a diffusion chamber that contains feedstock. The feedstock type and feedstock partial pressure are controlled by the type of feedstock loaded into the diffusion chamber and a temperature controlled bath surrounding the feedstock diffusion chamber. Through controlling the feedstock partial pressure, the temperature controlling device also impacts the reaction kinetics by increasing or decreasing the overall flow rates of the reaction.

As the feedstock/carrier gas mixture flows out of the diffusion chamber, its velocity is measured with a rotameter as it enters the reaction chamber. In this example, the reaction chamber is comprised of a quartz tube with a 4 inch inner diameter and 28 inch overall length. Approximately 2 inches above the inlets where the feedstock/carrier gas mixture enters the reaction chamber is a quartz fritted disc (4-15 micron pores) which acts to evenly distribute the gas flow over the inner area of the reaction chamber and prevent catalyst/product from falling below the reaction zone.

For the stated example, the catalyst type is controlled by the type of catalyst that is loaded into the reaction chamber. For this example, the catalyst is pre-loaded before the system begins to heat up and sits on top of the fritted disc in the reaction chamber. The catalyst load is controlled by the amount of catalyst loaded into the reaction chamber.

The temperature of the stated example is controlled by a Carbolite VST 12/400 furnace that surrounds the reaction chamber. The heated length of this furnace is 400 mm and runs from the top of the fritted disc to approximately 400 mm above the fritted disc, thus defining the reaction zone of the stated example to be a cylindrical volume with a 4 inch (100 mm) diameter and 400 mm length.

As the feedstock/carrier gas flows up through the fritted disc and comes in contact with the catalyst in the heated reaction zone, product forms. In the stated example, the catalyst and product remain in the reaction zone and do not become entrained in the feedstock/carrier gas flow. Thus the reaction duration is controlled by the amount of time new feedstock is introduced into the reaction zone at reaction conditions to allow product to form on the catalyst.

In the stated example, pressure is controlled with a Stra-Val RVi-20 in-line adjustable pressure relief valve located in the process flow after the reaction chamber. Reaction pressure is monitored with Omega PX309 pressure transducers (connected to Omega DPI-32 programmable meters) located below the fritted disc on the reaction chamber and at the reaction chamber exit.

For the above stated example of process flow of the present disclosure, catalyst is preloaded into the reaction chamber. As the furnace heats up to the desired reaction temperature, inert carrier gas is continuously flushed through the system. The reaction starts when the feedstock is introduced to the process flow by diverting the inert carrier gas to diffuse through temperature controlled feedstock and continue to the reaction zone to form product over catalyst. The reaction terminates when one or more of the reaction conditions are removed. For the above example this may occur when feedstock is no longer introduced into the reaction process flow, though the inert carrier gas will continue to flow through the system until it returns to room temperature. Once the feedstock is no longer being introduced, the furnace is turned off to return the system to room temperature and product is collected from inside the reaction chamber, and the collection chamber.

The following examples show at least some of the conditions used with embodiments of methods and/or systems of the present disclosure.

### Example 1

Reaction Specifications
Catalyst Type: Fe described in “Example Catalyst Preparation” and as characterized in FIG. 22-28.
Feedstock Type: Ethanol (90% vol.), Methanol (5% vol.), Isopropanol (5% vol.); Sigma-Aldrich 362808 Denatured Ethanol, Reagent Grade
Carrier Gas Type: N₂ Gas
Process Flow: Fluidized bed system as described in “Example Process Flow”

Reaction Conditions
Temperature: 681° C.
Pressure: 16.17 psia
Feedstock Partial Pressure: 54.3%
Reaction Kinetics: 2.18 meter/minute flow velocity (17.65 LPM overall flow) entering the reaction zone
Catalyst Load: 50.1 g
Reaction Duration: 24.32 minutes

### Product Characteristics

Characterization: The reaction product of said example is characterized in FIGS. 4-12. The product consists of multi-walled coiled carbon nanotubes that range in diameter from 20-400 nanometers (due to variance in catalyst size) and consist of a coiled length of 5 (+/−1) microns. The as-produced product of the said example is generally free of amorphous carbon. FIG. 12 confirms the graphene nature of the nanotubes by measuring the distance between the walls of a nanotube to be 0.34 nm (consistent with the spacing between stacked graphene layers found in multiwalled carbon nanotubes).

Carbon Yield: 9.0% of each carbon atom from the feedstock was converted to product during an 11 second residence time.

### Example 2

Reaction Specifications
Catalyst Type: Fe described in “Example Catalyst Preparation” and characterized in FIGS. 22-28.
Feedstock Type: Ethanol (90% vol.), Methanol (5% vol.), Isopropanol (5% vol.); Sigma-Aldrich 362808 Denatured Ethanol, Reagent Grade
Carrier Gas Type: N₂ Gas
Process Flow: Fluidized bed system as described in “Example Process Flow”

Reaction Conditions
Temperature: 681° C.
Pressure: 15.73 psia
Feedstock Partial Pressure: 50.9%
Reaction Kinetics: 2.16 meter/minute flow velocity (17.48 LPM overall flow) entering the reaction zone
Catalyst Load: 5.11 g
Reaction Duration: 24.32 minutes

### Product Characteristics

Characterization: The reaction product of the described example is characterized in FIGS. 13-21. The product consists of multi-walled coiled carbon nanotubes that range in diameter from 20-400 nanometers (due to variance in catalyst size) and consist of a coiled length of 5 (+/−1) microns. The as-produced product of the said example is generally free of amorphous carbon. FIG. 21 confirms the graphene nature of the nanotubes by measuring the distance between the walls of a nanotube to be 0.34 nm (consistent with the spacing between stacked graphene layers found in multiwalled carbon nanotubes).

Carbon Yield: 7.0% of each carbon atom from the feedstock was converted to product during an 11 second residence time.

### Example 3

Reaction Specifications
Catalyst Type: Iron Pentacarbonyl (floated)
Feedstock Type: Ethanol (90% vol.), Methanol (5% vol.), Isopropanol (5% vol.);
Sigma-Aldrich 362808 Denatured Ethanol, Reagent Grade
Carrier Gas Type: N₂ Gas

### Process Flow:

The process flow consists of an entrained bed system similar to that described in the section titled “Example Process Flow.” Differences are primarily due to the use of a floated catalyst and include no fritted disc, catalyst is not pre-loaded but introduced through a second diffusion chamber similar to that used for the feedstock, and the product/catalyst do not remain in the reaction zone but are entrained with the feedstock flow and vented.

Reaction Conditions
Temperature: 681° C.
Pressure: 17.13 psia
Feedstock Partial Pressure: 35.1%
Reaction Kinetics: 1.66 meter/minute flow velocity (13.49 LPM overall flow) entering the reaction zone
Catalyst Load: 0.8% partial pressure floated catalyst
Reaction Duration: 14 seconds (due to catalyst and product entrainment in feedstock flow)

### Product Characteristics

Characterization: The as-produced product of said example is characterized in FIGS. 29-37. The product consists of diamond nanoparticles that range in diameter from 20-80 nanometers and are generally free of amorphous carbon. FIG. 37 confirms the produce consists of the diamond allotrope of carbon by measuring the distance lattice interplanar spacing to be 0.21 nm; consistent with (111) diamond.

Carbon Yield: 12% of each carbon atom from the feedstock was converted to product during a 14 second residence time.

I claim:

1. A method of producing coiled carbon nanotubes, the method comprising the step of:
reacting a carbon feedstock and a catalyst within a reaction vessel to produce a reaction product comprising at least about 5% coiled carbon nanotubes;
wherein the carbon feedstock comprises either (i) a mixture of a hydrocarbon and water or (ii) an alcohol; and
wherein the catalyst comprises at least one Group VIB or VIIIB transition metal.

2. The method of claim 1, wherein the carbon feedstock comprises an alcohol selected from a group consisting of methanol, ethanol, butyl alcohol, and propyl alcohol.

3. The method of claim 1, wherein the hydrocarbon has three or greater carbon atoms.

4. (canceled)

5. (canceled)

6. The method of claim 1, wherein the carbon feedstock further comprises an inert gas is selected from the group consisting of a noble gas, N₂, and either a noble gas or N₂ combined with one or more of CO, CO₂, H₂O, and H_{Z}.

7. (canceled)

8. The method of claim 1, wherein the catalyst comprises a metal selected from the group consisting of Fe, Cobalt (Co), and Fe combined with one or more of Co, Mo, or W.

9. (canceled)

10. (canceled)

11. (canceled)

12. The method of claim 1, wherein the step of reacting the carbon feedstock with the catalyst uses a process flow selected from the group consisting of a fluidized bed, entrained bed, raining bed, and direct injection.

13. The method of claim 1, further comprising the step of heating the reaction vessel to a reaction temperature selected from the group consisting of about 400° C. to about 1200° C., about 550° C. to about 1000° C., about 600° C. to about 825° C., and about 625° C. to about 700° C.

14. The method of claim 1, further comprising the step of pressurizing the reaction vessel to an internal pressure selected from a group consisting of about 14.7 psia to about 65 psia, about 14.7 psia to about 45 psia, about 14.7 psia to about 30 psia, and about 14.7 psia to about 20 psia.

15. The method of claim 1, wherein the carbon feedstock is introduced into the reaction vessel at a feedstock partial pressure selected from the group consisting of at least about 10%, at least about 20%, at least about 30%, at least about 40%, at least about 50%, at least about 60%, and at least about 70%.

16. (canceled)

17. The method of claim 1, wherein the coiled carbon nanotubes are primarily multi-walled.

18. (canceled)

19. The method of claim 1, wherein the coiled carbon nanotubes have a diameter of about 1 nm to about 500 nm.

20. (canceled)

21. (canceled)

22. (canceled)

23. (canceled)

24. (canceled)

25. (canceled)

26. (canceled)

27. A method of producing coiled carbon nanotubes, the method comprising the step of:
reacting a carbon feedstock and a catalyst within a reaction vessel to produce a reaction product comprising at least about 5% coiled carbon nanotubes;
wherein the carbon feedstock comprises ethanol or a mixture of ethylene and water; and
wherein the catalyst comprises iron.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (cancelled)

48. (cancelled)

49. (cancelled)

50. (cancelled)

51. (cancelled)

52. (cancelled)

53. (cancelled)

54. (cancelled)

55. (cancelled)

56. (cancelled)

57. (cancelled)

58. (cancelled)

59. (cancelled)

60. (cancelled)

61. (cancelled)

62. (cancelled)

63. A method of producing diamond nanoparticles, the method comprising the steps of:
reacting a carbon feedstock and a catalyst within a reaction vessel to produce a reaction product comprising at least 1% diamond nanoparticles, Page 8
wherein the carbon feedstock comprises either (i) a mixture of a hydrocarbon and water or (ii) an alcohol, and
wherein the catalyst comprises at least one Group VIB or VIIIB transition metal; and
introducing iron pentacarbonyl into the reaction vessel.

64. (canceled)

65. The method of claim 27, wherein the carbon feedstock further comprises an inert gas is selected from the group consisting of a noble gas, N₂, and either a noble gas or N₂ combined with one or more of CO, CO₂, H₂O, and H₂.

66. The method of claim 27, wherein the step of reacting the carbon feedstock with the catalyst uses a process flow selected from the group consisting of a fluidized bed, entrained bed, raining bed, and direct injection.

67. The method of claim 27, further comprising the step of heating the reaction vessel to a reaction temperature selected from the group consisting of about 400° C. to about 1200° C., about 550° C. to about 1000° C., about 600° C. to about 825° C., and about 625° C. to about 700° C.

68. The method of claim 27, further comprising the step of pressurizing the reaction vessel to an internal pressure selected from a group consisting of about 14.7 psia to about 65 psia, about 14.7 psia to about 45 psia, about 14.7 psia to about 30 psia, and about 14.7 psia to about 20 psia.

69. The method of claim 27, wherein the carbon feedstock is introduced into the reaction vessel at a feedstock partial pressure selected from the group consisting of at least about 10%, at least about 20%, at least about 30%, at least about 40%, at least about 50%, at least about 60%, and at least about 70%.

70. The method of claim 27, wherein the coiled carbon nanotubes are primarily multi-walled.

71. The method of claim 27, wherein the coiled carbon nanotubes have a diameter of about 1 nm to about 500 nm.
